(19) United States
(12) Patent Application Publication
(10) Pub. No.: US 2019/0197593 A1
(43) Pub. Date: Jun. 27, 2019

(54) Image processing and information extraction system and method for workflow processing of purchase request semantic models

(71) Applicant: Todd E. Lewis, New Port Richey, FL (US)

(72) Inventor: Todd E. Lewis, New Port Richey, FL (US)

(21) Appl. No.: 15/850,574

(22) Filed: Dec. 21, 2017

(51) Int. Cl. G06Q 30/06; G06F 17/27; G06K 9/00; G06Q 10/06

(52) U.S. Cl. CPC G06Q 30/0611; G06F 17/2705; G06F 3/0482; G06Q 10/06316; G06K 2209/01; G06K 9/00469

(57) ABSTRACT

A system for quotation workflow processing includes: a quotation workflow server, including a processor, a non-transitory memory, an input/output component, a quotations manager, a quotation parser, and a sales database; a quotation workflow device; an e-commerce system; and a quotation system, such that the quotation workflow server extracts a quotation text string from a quotation document and generates a quotation structure, which is matched against the sales database to identify matching sales items for purchase in the e-commerce system. Also disclosed is a method for quotation workflow processing, including: extracting, parsing, matching quotation, and purchasing sales items.

### CROSS-REFERENCE TO RELATED APPLICATIONS

N/A.

### FIELD OF THE INVENTION

The present invention relates generally to the field of image and document processing for semantic extraction and workflow processing, and more particularly to methods and systems for generating standard quotations from variable format purchase requests.

### BACKGROUND OF THE INVENTION

Businesses typically operate according to a well-established formal procurement process wherein purchase orders are filled by established vendors who ship products and issue corresponding invoices.

However, the conventional procurement process is not well matched to flexible interaction with emerging online vendors, bidding among multiple sources, who may have different requirements with respect to data integration.

As such, considering the foregoing, it may be appreciated that there continues to be a need for novel and improved devices and methods for processing of purchase requests and requesting quotations.

### SUMMARY OF THE INVENTION

The foregoing needs are met, to a great extent, by the present invention, wherein in aspects of this invention, enhancements are provided to the existing model of for processing of purchase requests and requesting quotations.

In an aspect, a system for quotation workflow processing, can include:
a) a quotation workflow server; and
b) a quotation workflow device, which is connected to the quotation workflow server;
wherein the price quotation device receives a quotation document, such that the price quotation device sends the quotation document to the quotation workflow server for processing; wherein the quotation workflow server performs pre-processing of the quotation document to extract a quotation text string; wherein the quotation workflow server parses the quotation text string to create a quotation structure; wherein the quotation structure is matched against a sales database to identify matching sales items for selection by a user.

In another aspect, a method for quotation workflow processing can include:
a) extracting quotation, wherein a quotation text string is extracted from a quotation document;
b) parsing quotation, wherein the quotation text string is parsed to create a quotation structure;
c) matching quotation, wherein the quotation structure is matched against a sales database to identify matching sales items for selection by a user; and
d) purchasing sales items, wherein the sales items are purchased in communication with an e-commerce system.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for quotation workflow processing, according to an embodiment of the invention.

FIG. 2 is a schematic diagram illustrating a quotation workflow server, according to an embodiment of the invention.

FIG. 3 is a schematic diagram illustrating a quotation workflow device, according to an embodiment of the invention.

FIG. 4 is a flowchart illustrating steps that may be followed, in accordance with one embodiment of a method or process of quotation workflow processing.

FIG. 5 is a schematic diagram illustrating a quotation structure, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

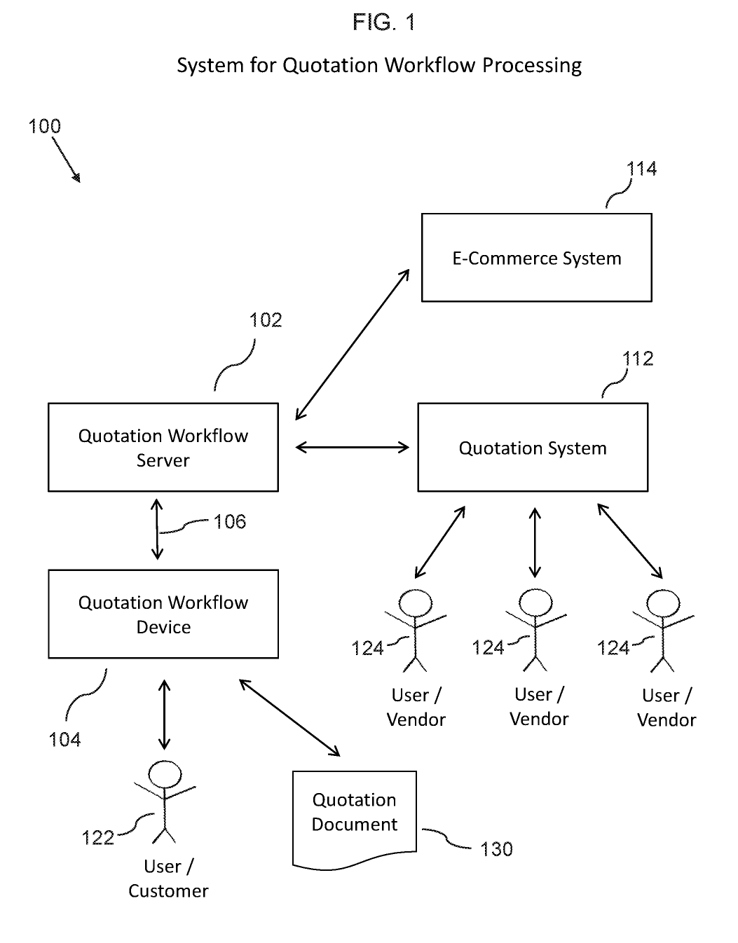

In the following, we describe the structure of an embodiment of a system for quotation generation 100 with reference to FIG. 1, in such manner that like reference numerals refer to like components throughout; a convention that we shall employ for the remainder of this specification.

In an embodiment, a system for quotation workflow processing 100 can include:
a) A quotation workflow server 102; and
b) A quotation workflow device 104, which is connected to the quotation workflow server;
wherein the price quotation device 104 can be configured to receive a quotation document 130, which for example can be an image or text document, stored as for example a PDF, JPG, GIFF, etc., containing script or handwritten text;
such that the price quotation device 104 sends the quotation document 130 to the quotation workflow server 102 for processing;
wherein the quotation workflow server 102 extracts a flat quotation text string from the quotation document 130, for example via use of well-known image processing methods/algorithms for optical character recognition;
wherein the quotation workflow server 102 can parse the quotation text string to create a quotation structure, which is a structured data object, which for example can be represented as a BNF syntax, and can be encoded as an extensible markup language (XML) object or a javascript object notation (JSON) object;
wherein the quotation structure is matched against a sales database to identify matching sales items for selection by the user 122;
wherein, the quotation workflow server 102 can be configured to communicate with an e-commerce system 114 to purchase the matching sales items. The e-commerce system 114 can for example be a web based e-commerce system 114, such as AMAZON′″ and EBAY;
whereby the quotation workflow server is performing image processing of the quotation document to extract a quotation text string, perform a semantic extraction by parsing the quotation text string into a quotation structure, which forms a purchase request semantic model that is matched against a sales database to identify matching sales items.

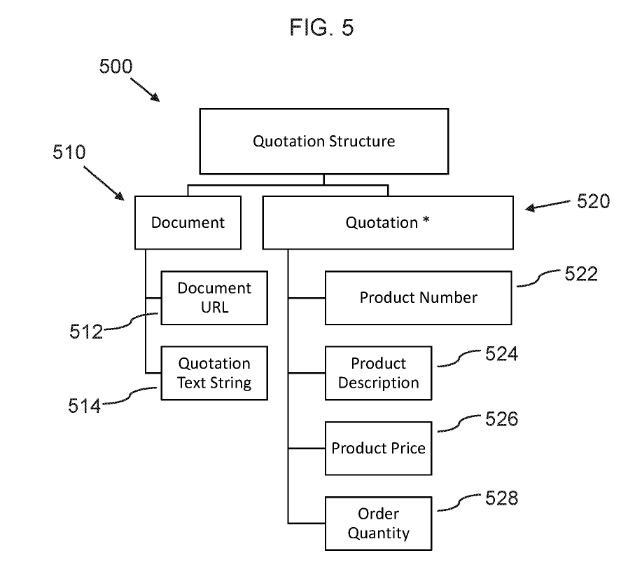

In a related embodiment, as shown in FIG. 5, the quotation structure 500, can include a plurality of quotations 520 or at least one quotation 520, including:
a) a product number 522, which for example can be a stock keeping unit (SKU), such that the product number 522 is a unique identifier;
b) a product description 524, which is a textual description of the product;
c) a product price 526, which is a number that denotes a price for the product, which can be interpreted as a maximum price the user 122 is willing to pay; and
d) an order quantity 528, which is a numerical quantity of the product as requested for quotation;
whereby the quotation structure defines a semantic model for the quotation document 130, comprising purchasing information extracted by image processing and parsing.

In a further related embodiment, the quotation structure 500 can optionally further include a document record 510:
a) A document uniform resource locator 512 (URL), which points to an instance of the quotation document 130; and
b) The quotation text string 514, which is the quotation text string that was extracted from the quotation document 130;
whereby the document record 500 can for example be used for validation of content in the at least one quotation structure, and be used to preserve an audit trail.

In a related embodiment, the quotation workflow server 102 can send the quotation structure to a quotation system 112 for bidding among a plurality of vendors 124, such that a winning bid is returned to the quotation workflow server 102.

In a related embodiment, the quotation structure can be defined in a specification language, including:
a) XML or variants of XML;
b) Other markup languages;
c) Script and object notation languages, such as JSON;
d) Context free grammar definition languages, such as BNF; or
e) Other data structure specification languages.

In a related embodiment, the quotation structure can be sent to a quotation system 112 for bidding among a plurality of vendors 124, such that qualifying bids can be returned to the quotation workflow server 102.

In a related embodiment, a quotation workflow server 102 can include:
a) A processor 202;
b) A non-transitory memory 204;
c) An input/output component 206;
d) A quotation manager 210, which can be configured to control workflow processing;
e) A quotation parser 212, which can be configured to parse the quotation document 130 to generate a quotation structure;
f) A sales database 214, which can be accessed by the quotation manager 210 to match a quotation structure against records in the sales database 214 to identity matching sales items; all connected via
g) A data bus 220.

In a related embodiment, a quotation workflow device 104 can include:
a) A processor 302;
b) A non-transitory memory 304;
c) An input/output 306;
d) A quotation controller 310, which can be configured to interact with a user 122 to send a quotation document 130 (or a link/reference such as a URL) to the quotation workflow server 102, and receive matching sales items and winning bids from the quotation workflow server 102; and
e) A quotation viewer 312; which can be configured to allow a user 122 to view quotation documents, sales items, and winning bids; all connected via
f) A data bus 320.

In related embodiments, the quotation workflow device 104 can include configurations as:
a) A web application, executing in a Web browser;
b) A tablet app, executing on a tablet device, such as for example an Android or iOS tablet device;
c) A mobile app, executing on a mobile device, such as for example an Android phone or iPhone, or any wearable mobile device;
d) A desktop application, executing on a personal computer, or similar device;
e) An embedded application, executing on a processing device, such as for example a smart TV, a game console or other system.

It shall be understood that an executing instance of an embodiment of the system for quotation generation 100, as shown in FIG. 1, can include a plurality of quotation workflow devices 104, which are each tied to one or more users 122.

An executing instance of an embodiment of the system for quotation workflow processing 100, as shown in FIG. 1, can similarly include a plurality of quotation workflow servers 102.

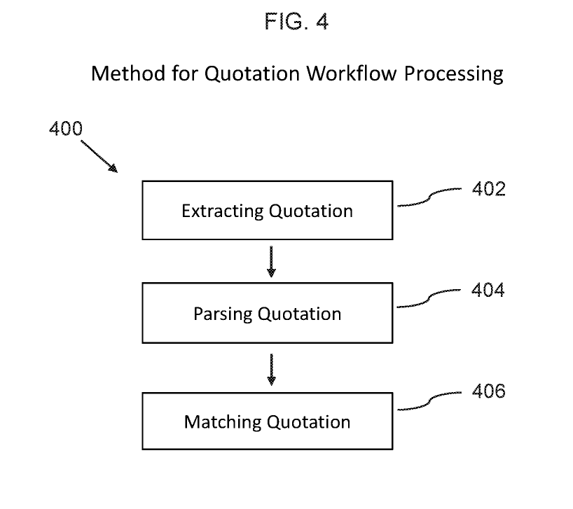

In an embodiment, as illustrated in FIG. 4, a method for quotation workflow processing 400 can include:
a) Extracting quotation 402, wherein a quotation text string is extracted from a quotation document 130, for example via use of well-known image processing methods/algorithms for optical character recognition;
b) Parsing quotation 404, wherein the quotation text string is parsed to create a quotation structure;
c) Matching quotation 406, wherein the quotation structure is matched against a sales database to identify matching sales items for selection by the user; and
d) Purchasing sales items 408, wherein the sales items are purchased in communication with an e-commerce system 114.

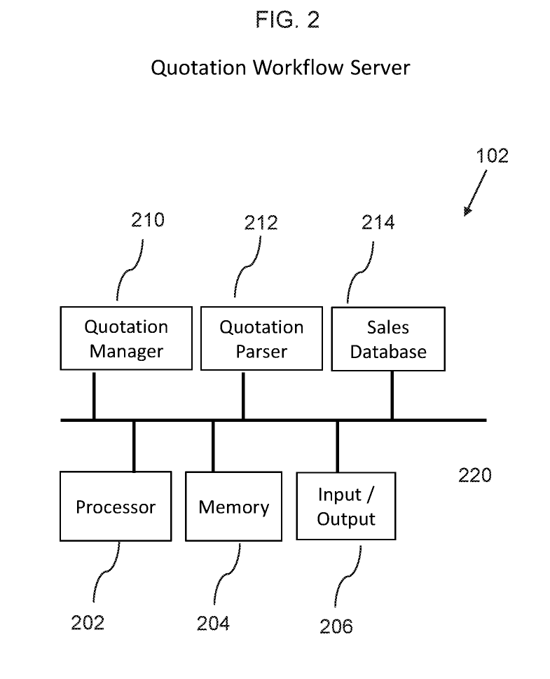

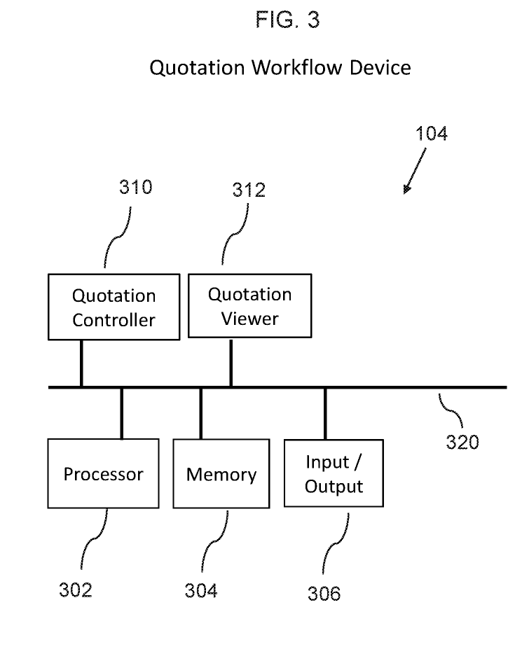

FIGS. 1, 2, 3 and 4 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for quotation generation 100, including the quotation workflow server 102, and the quotation workflow device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the quotation workflow server 102 and the quotation workflow device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the quotation workflow server 102 and the quotation workflow device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the quotation workflow device 104 communicates with the quotation workflow server 102 over a network 106, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the quotation generation system 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the quotation workflow server 102 and the quotation workflow device 104. The components of the quotation workflow server 102 can be distributed over a plurality of physical, logical, or virtual servers. Parts or all of the components of the quotation workflow device 104 can be configured to operate in the quotation workflow server 102, whereby the quotation workflow device 104 for example can function as a thin client, performing only graphical user interface presentation and input/output functions. Alternatively, parts or all of the components of the quotation workflow server 102 can be configured to operate in the quotation workflow device 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for quotation workflow processing, comprising:
a) a quotation workflow server; and
b) a quotation workflow device, which is connected to the quotation workflow server;
wherein the price quotation device is configured to receive a quotation document;
such that the price quotation device is configured to send the quotation document to the quotation workflow server for processing;
wherein the quotation workflow server is configured to performs pre-processing of the quotation document to extract a quotation text string from the quotation document;
wherein the quotation workflow server is configured to parse the quotation text string to create a quotation structure;
wherein the quotation structure is matched against a sales database to identify matching sales items for selection by a user.

2. The system for quotation workflow processing of claim 1, wherein the quotation document is an image document and the quotation text string is extracted from the quotation document via optical character recognition.

3. The system for quotation workflow processing of claim 1, further comprising:
an e-commerce system;
wherein the quotation workflow server is configured to communicate with the e-commerce system to purchase the matching sales items.

4. The system for quotation workflow processing of claim 1, wherein the quotation structure comprises at least one quotation, comprising:
a) a product number, which is a unique identifier;
b) a product description, which is a textual description;
c) a product price, which is a number; and
d) an order quantity, which is a numerical quantity.

5. The system for quotation workflow processing of claim 1, wherein the quotation structure is defined in a specification language, selected from the group consisting of:
a) an extensible markup language;
b) javascript object notation; and
c) a context free grammar definition language.

6. The system for quotation workflow processing of claim 1, further comprising:
a quotation system;
wherein the quotation workflow server is configured to send the quotation structure to a quotation system for bidding among a plurality of vendors, such that a winning bid is returned to the quotation workflow server.

7. The system for quotation workflow processing of claim 1, wherein the quotation workflow server further comprises:
a) a processor;
b) a non-transitory memory;
c) an input/output component;
d) a quotation manager, which is configured to control workflow processing;
e) a quotation parser, which is configured to parse the quotation document to generate the quotation structure; and
f) the sales database, which is accessed by the quotation manager to match the quotation structure against records in the sales database to identity the matching sales items; all connected via
g) a data bus.

8. The system for quotation workflow processing of claim 1, wherein the quotation workflow device further comprises:
a) a processor;
b) a non-transitory memory;
c) an input/output;
d) a quotation controller, which is configured to interact with the user to send the quotation document to the quotation workflow server, such that the quotation controller receives the matching sales items from the quotation workflow server; and
e) a quotation viewer; which is configured to allow the user to view the quotation document and the matching sales items, and winning bids; all connected via
f) a data bus.

9. A quotation workflow server, comprising:
a) a processor;
b) a non-transitory memory;
c) an input/output component;
d) a quotation manager, which is configured to control workflow processing;
e) a quotation parser, which is configured to parse a quotation document to generate a quotation structure;
f) a sales database, which is accessed by the quotation manager to match the quotation structure against records in the sales database to identity the matching sales items; all connected via
g) a data bus;
wherein the quotation workflow server is configured to receive the quotation document for processing;
wherein the quotation workflow server is configured to performs pre-processing of the quotation document to extract a quotation text string from the quotation document;
wherein the quotation workflow server is configured to parse the quotation text string to create the quotation structure;
wherein the quotation workflow server is configured to match the quotation structure against a sales database to identify matching sales items for selection by a user.

10. The quotation workflow server of claim 9, wherein the quotation document is an image document and the quotation text string is extracted from the quotation document via optical character recognition.

11. The quotation workflow server of claim 9, wherein the quotation structure comprises at least one quotation, comprising:
a) a product number, which is a unique identifier;
b) a product description, which is a textual description;
c) a product price, which is a number; and
d) an order quantity, which is a numerical quantity.

12. The quotation workflow server of claim 9, wherein the quotation structure is defined in a specification language, selected from the group consisting of:
a) an extensible markup language;
b) javascript object notation; and
c) a context free grammar definition language.

13. A method for quotation workflow processing, comprising:
a) extracting quotation, wherein a quotation text string is extracted from a quotation document;
b) parsing quotation, wherein the quotation text string is parsed to create a quotation structure; and
c) matching quotation, wherein the quotation structure is matched against a sales database to identify matching sales items for selection by the user.

14. The method for quotation workflow processing of claim 13, further comprising:
purchasing sales items, wherein the matching sales items are purchased in communication with an e-commerce system.

15. The method for quotation workflow processing of claim 13, wherein the quotation document is an image document and the quotation text string is extracted from the quotation document via optical character recognition.

16. The method for quotation workflow processing of claim 13, wherein the quotation structure comprises at least one quotation, comprising:
a) a product number, which is a unique identifier;
b) a product description, which is a textual description;
c) a product price, which is a number; and
d) an order quantity, which is a numerical quantity.

17. The method for quotation workflow processing of claim 13, wherein the quotation structure is defined in a specification language, selected from the group consisting of:
a) An extensible markup language;
b) javascript object notation; and
c) a context free grammar definition language.

18. The method for quotation workflow processing of claim 13, further comprising sending the quotation structure to a quotation system for bidding among a plurality of vendors to identify a winning bid.
